(19) United States
(12) Patent Application Publication
(10) Pub. No.: US 2011/0096550 A1
(43) Pub. Date: Apr. 28, 2011

(54) LAMP WITH SNOW REMOVING STRUCTURE

(75) Inventors: CHIN-LONG KU, Tu-Cheng (TW); CHIN-WEN YEH, Tu-Cheng (TW); ZHEN-NENG LIN, Shenzhen City (CN)

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/763,153

(22) Filed: Apr. 19, 2010

(30) Foreign Application Priority Data
Oct. 27, 2009 (CN) 200910308876.1

(51) Int. Cl. F21V 7/00; F21V 21/30

(52) U.S. Cl. 362/296.01; 362/428

(57) ABSTRACT

A lamp includes a bracket including a shaft and a limiting member and a lamp body pivotably engaged with the shaft. The lamp body includes a luminous portion and a counterweight portion at different sides of the shaft. When the lamp body is at a first position, the luminous portion of the lamp body abuts the limiting member; when the luminous portion is subjected to an exterior force which is caused by weight of snow/ice accumulated on the luminous and excesses a set value, the lamp body rotates around the shaft from the first position to a second position; when the exterior force disappears or decreases to be less than the set value, the lamp body returns from the second position to the first position. The lamp can automatically remove the snow/ice accumulated on the lamp body.

### BACKGROUND

1. Technical Field

The present disclosure relates to a lamp and, more particularly, to a lamp with snow removing structure, whereby snow on a top of the lamp can automatically leave the lamp when the snow is accumulated to a certain amount.

2. Description of Related Art

An outdoor lamp such as a street lamp is widely installed throughout the country due to road safety and security purpose. Conventionally, the street lamp includes a lamp post and a lamp body fastened at a top of the lamp post. A light source with high luminance irradiation is installed in a bottom of the lamp body and provides light to the ground. However, since the lamp body is exposed to ambient air, the lamp body is often covered with snow or ice in snow/snowstorm day. The snow or ice accumulates on the lamp body, if too much, possibly causes a heavy load on the lamp body which may result in a damage to the lamp body or even a break of the lamp from the lamp post.

What is needed, therefore, is a lamp with snow removing structure to remove snow or ice thereon when the snow or ice accumulated thereon reaches a predetermined amount.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

Moreover, in the drawings, like reference numerals designate corresponding parts throughout the several views.

FIG. 1 is an assembled view of a lamp in accordance with an embodiment of the present disclosure.

FIG. 2 is a side view of the lamp of FIG. 1.

FIG. 3 is a cross-sectional view of the lamp of FIG. 1, taken along line thereof, with snow/ice accumulated on a top of a lamp body thereof.

FIG. 4 is an assembled view of a bracket and cover of the lamp of FIG. 1.

FIG. 5 is a view similar to FIG. 3, wherein a lamp body rotates to another position different from that of FIG. 3 and some of the snow accumulated on the top of the lamp body leaves therefrom.

### DETAILED DESCRIPTION

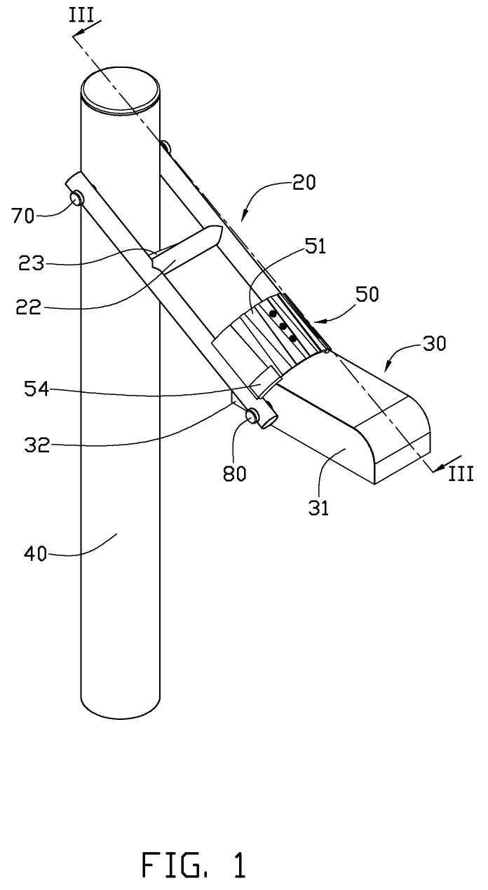

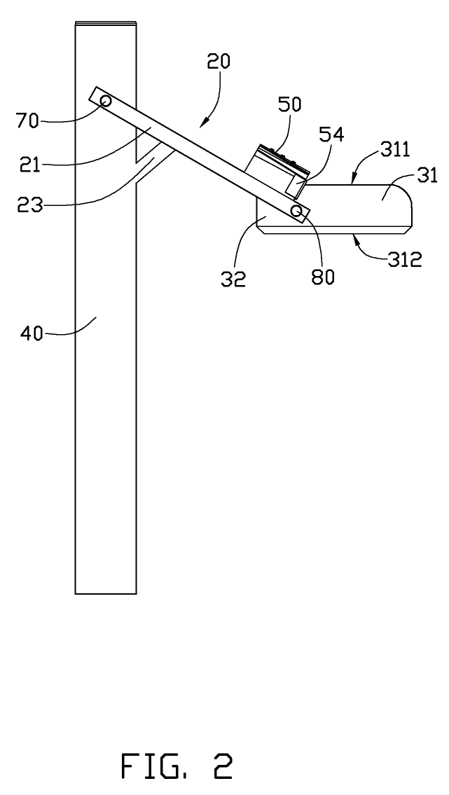

Referring to FIGS. 1-3, a lamp 10 in accordance with an embodiment of the disclosure is illustrated. The lamp 10 is an outdoor lamp such as a street lamp, a landscape lamp, and so on. The lamp 10 comprises an inclined bracket 20 and a lamp body 30 pivotably engaged with a bottom end of the bracket 20. The lamp 10 further comprises a lamp post 40 to engage a top end of the bracket 20 for supporting the lamp body 30. In other embodiment, the lamp post 40 can be omitted, and the bracket 20 may be installed onto a wall. The bracket 20 includes a limiting member to limit a rotation of lamp body 30. In this embodiment, the limiting member is a cover 50 located above a top of a lateral portion of the lamp body 30. In other embodiment, the limiting member can be a part of the bracket 20, such as an additional beam.

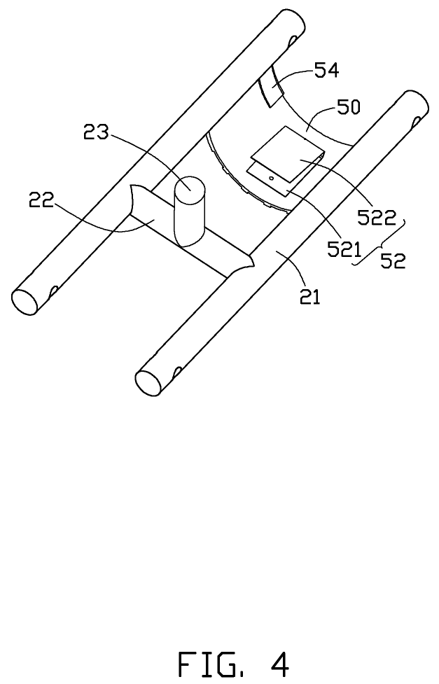

Referring also to FIG. 4, the top end of the bracket 20 is firmly fixed to the lamp post 40 via a fastener 70, and the bottom end thereof is pivotably connected with the lamp body 30 via a shaft 80. The bracket 20 includes two main beams 21, a middle beam 22 and a supporting beam 23. The main beams 21 extend slantways from the lamp post 40. The middle beam 22 vertically connects with middle portions of the main beams 21, whereby the middle beam 22 and the main beams 21 form an H-shaped profile. The supporting beam 23 connects the middle beam 22 and the lamp post 40 to enhance the rigidity of the bracket 20.

The cover 50 is mounted on the main beams 21 of the bracket 20 and adjacent to the lamp body 30. The cover 50 has a convex configuration. Two lateral edges of the cover 50 are soldered on and adjacent to free end portions of the main beams 21, respectively. Middle portion of the cover 50 is convex upwardly and hovers on the free end portions of the main beams 21 and a rear portion of the lamp body 30. The cover 50 extends along the main beams 21 and substantially parallel to the main beams 21, whereby the cover 50 is slantways relative to a horizontal plane (i.e. the ground plane). The cover 50 defines a plurality of grooves 51 at a top surface thereof. The grooves 51 extend slantways from top to bottom and each of the grooves 51 has a wider top end and a narrow bottom end. An elastic member is fixed at central portion of a bottom surface of the cover 50. In this embodiment, the elastic member is a leaf spring 52. The leaf spring 52 is U-shaped and made of metal. The leaf spring 52 is located above the lamp body 30, comprising a mounting portion 521 and an elastic portion 522. The mounting portion 521 is secured to the bottom surface of the cover 50 via fasteners such as screws (not labeled). Alternatively, the leaf spring 52 can be directly mounted on the bracket 20. The leaf spring 52 defines an opening towards to the lamp post 40, whereby a free end of the elastic portion 522 spaces a distance from the bottom surface of the cover 50. Two shock absorbers 54 are mounted at two sides of the bottom end of the cover 50, respectively. The shock absorbers 54 can be made of rubber.

The lamp body 30 is pivotably connected with free ends of the main beams 21 via the shaft 80 extending therethrough. The lamp body 30 is divided into a front portion remote from the cover 50 and the rear portion adjacent to the cover 50 by the shaft 80. In this embodiment, the front portion functions as a luminous portion 31, and the rear portion functions as a counterweight portion 32. The luminous portion 31 includes a light source such as an LED light source therein. The luminous portion 31 has a top surface 311 and a bottom surface 312. The bottom surface 312 is used as a light emitting surface. The counterweight portion 32 is located near the bracket 20, and the luminous portion 31 is remote from the bracket 20. A bottom end of the cover 50 is located above the top surface 311 of the luminous portion 31. The luminous portion 31 is longer than the counterweight portion 32 so that the luminous portion 31 has larger area for emitting light. The counterweight portion 32 is heavier than the luminous portion 31 to drive the top surface 311 of the luminous portion 31 to upwardly and tightly abut against the shock absorbers 54 at the bottom of the cover 50. Thus, the bottom surface 312 of the luminous portion 31 is held in a substantially horizontal position thereby to facilitate lighting the ground. The counterweight portion 32 spaces a distance from the elastic portion 522 of the leaf spring 52.

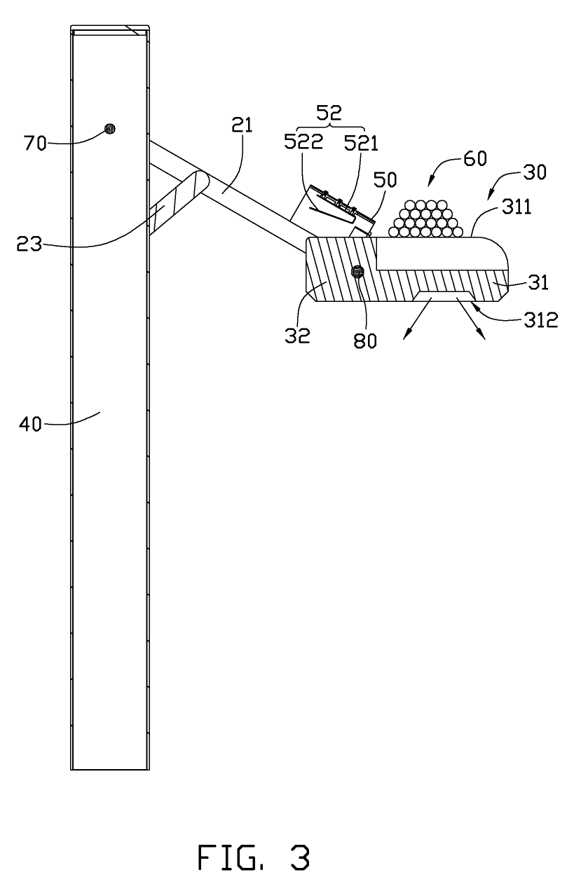

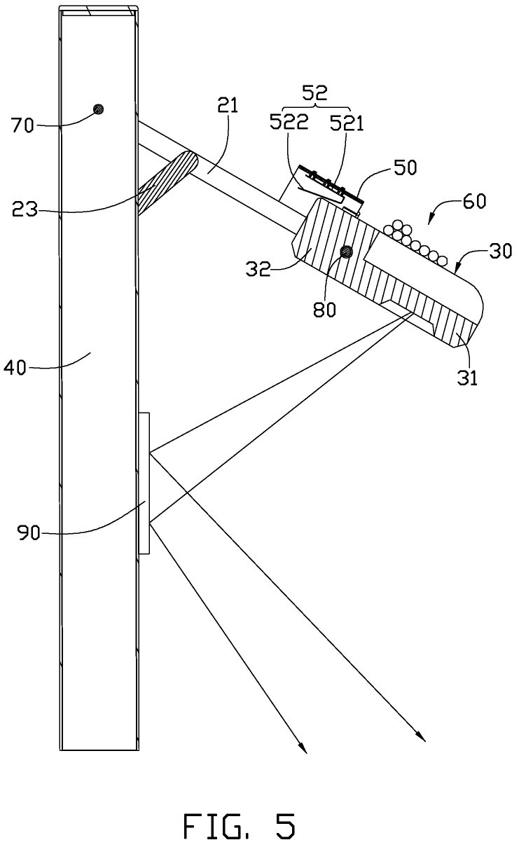

Referring also to FIG. 5, in a snow/snowstorm day, snow 60 falls and accumulates on the cover 50 and the top of the luminous portion 31 of the lamp body 10. The snow 60 accumulated on the top surface 311 of the luminous portion 31 provides a weight on the luminous portion 31. When the snow 60 gradually accumulates more and more on the luminous portion 31 and the weight of the snow reaches a critical value, the weight of the snow 60 drives the luminous portion 31 to rotate around the shaft 80 clockwise as viewed from FIG. 3; in other word, the lamp body 30 rotates around the shaft 80 clockwise (seen in FIG. 3 and FIG. 5). The top surface 311 of the luminous portion 31 rotates from a substantially horizontal position to a slantwise position. The snow 60 accumulated on the luminous portion 31 is moved to be in a slantwise position accordingly. In this embodiment, the lamp body 30 is substantially parallel to the main beams 21 of the bracket 20 when the lamp body 30 is in the slantwise position. Simultaneously, the counterweight portion 32 rotates upwardly around the shaft 80 and collides the elastic portion 522 of the leaf spring 52; thus, the cover 50 vibrates by the collision of the counterweight portion 32 to make the snow 60 on the cover 50 leave from the cover 50 to the top surface 311 of the luminous portion 31. Meanwhile, the snow 60 on the top surface 311 slides away from the top surface 311 and falls onto the ground by the weight thereof, as viewed from FIG. 5. Therefore, the snow 60 on the cover 50 and the lamp body 30 is mostly removed therefrom by the rotation of the lamp body 30 around the shaft 80. Since the snow 60 becomes little and the weight of the snow 60 reduces to be less than the critical value, then, the weight of the counterweight portion 32 drives the lamp body 30 to rotate around the shaft 80 counterclockwise to return to its original position until the top surface 311 of the luminous portion 31 upwardly abut against the shock absorbers 54 at the bottom of the cover 50. The lamp body 30 resumes in a substantially horizontal position. In this embodiment, the leaf spring 52 helps the lamp body 30 to return quickly via an elasticity thereof. When the snow 60 on the top surface 311 accumulates to the predetermined amount again, the lamp body 10 rotates again to enable the snow 60 accumulated on the top surface 311 to leave therefrom and fall onto the ground.

In this embodiment, a reflector 90 is vertically mounted on a lower end of the lamp post 40 to face a side of the lamp body 30. When the lamp body 30 is in the slantwise position to enable the snow 60 to leave therefrom, light emitting from the luminous portion 31 is reflected by the reflector 90 to illuminate to the ground. Therefore, the lamp body 30 can illuminate the ground at the same time when the lamp body 30 is rotated to the slantwise position.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A lamp, comprising:
a bracket comprising a shaft and a limiting member; and
a lamp body pivotably engaged with the shaft of the bracket, the lamp body comprising a luminous portion at a side of the shaft and a counterweight portion at an opposite of the shaft;
wherein when the lamp body is at a first position, the luminous portion of the lamp body abuts the limiting member; when the luminous portion is subjected to an exterior force acting thereon which is beyond a set value, the lamp body rotates around the shaft from the first position to a second position; when the exterior force disappears or decreases to less than the set value, the lamp body returns from the second position to the first position, the exterior force being exerted on the luminous portion by weight of snow/ice accumulated on the luminous portion.

2. The lamp as claimed in claim 1, wherein the limiting member of the bracket is located above the luminous portion of the lamp body, the limiting member having a bottom end abutting a top surface of the luminous portion when the lamp body is at the first position.

3. The lamp as claimed in claim 2, wherein the bottom end of the limiting member has a shock absorber to contact the luminous portion of the lamp body when the lamp body is at the first position.

4. The lamp as claimed in claim 1, wherein the bracket further comprises an elastic member to resist the counterweight portion when the lamp body is at the second position.

5. The lamp as claimed in claim 4, wherein the elastic member is a leaf spring comprising a mounting portion and an elastic portion to resist the counterweight portion, and the leaf spring is U-shaped and made of metal.

6. The lamp as claimed in claim 1, wherein the limiting member is a cover to cover the counterweight portion.

7. The lamp as claimed in claim 6, wherein the cover is slantwise relative to the lamp body when the lamp body is at the first position, the cover defining a plurality of grooves at a top surface thereof, the grooves having a wider top end and a narrow bottom end.

8. The lamp as claimed in claim 1, wherein the bracket comprises two parallel main beams, a middle beam connecting with the main beams, and a supporting beam supporting the middle beam, the shaft engaging with bottom ends of the main beams.

9. The lamp as claimed in claim 8, further comprising a lamp post connecting the bracket, a reflector being mounted on a lower end of the lamp post to reflect light emitting from the luminous portion of the lamp body when the lamp body is at the second position.

10. A lamp, comprising:
a bracket comprising a shaft and a cover; and
a lamp body pivotably engaged with the shaft of the bracket, the lamp body comprising a first part at a side of the shaft and a and a second part at an opposite of the shaft;
wherein when the lamp body is at a first position, the first part of the lamp body abuts an end of the cover; when the first part is subjected to an exterior force beyond a set value, the lamp body rotates around the shaft from the first position to a second position;
when the exterior force disappears or decreases to be less than the set value, the lamp body returns from the second position to the first position, the exterior force being exerted on the first part by weight of snow/ice accumulated on the first part.

11. The lamp as claimed in claim 10, wherein the cover is located above the first part of the lamp body.

12. The lamp as claimed in claim 11, wherein the bracket further comprises a leaf spring having a mounting portion and an elastic portion, the elastic portion resisting the second part when the lamp body is at the second position.

13. The lamp as claimed in claim 12, wherein the leaf spring is U-shaped and made of metal.

14. The lamp as claimed in claim 11 further comprising a reflector and when the lamp body is at the second position light emitted from the lamp body is reflect by the reflector to illuminate.
